(19) United States
(12) Patent Application Publication
(10) Pub. No.: US 2026/0148716 A1
(43) Pub. Date: May 28, 2026

(54) Method of saving power consumption and display driver circuit using the same

(71) Applicant: NOVATKE Microelectronics Corp., Hsin-Chu (TW)

(72) Inventor: Chi-Yi Lo, Kaohsiung City (TW)

(73) Assignee: NOVATKE Microelectronics Corp., Hsin-Chu (TW)

(21) Appl. No.: 19/401,387

(22) Filed: Nov. 26, 2025

Related U.S. Application Data
(60) Provisional application No. 63/724,911, filed on Nov. 26, 2024.

(51) Int. Cl. G09G 5/00

(52) U.S. Cl. CPC G09G 5/006; G09G 2330/022; G09G 2360/08; G09G 2370/04

(57) ABSTRACT

A method for a display driver circuit includes steps of: receiving display data through a display interface; detecting whether the display driver circuit enters a non-active state in which the display driver circuit stops refreshing a display panel; and in response to detecting that the display driver circuit enters the non-active state, configuring a power supply state for an internal circuit of the display driver circuit to save power consumption of the internal circuit.

### CROSS REFERENCE TO RELATED APPLICATIONS

This application claims the benefit of U.S. Provisional Application No. 63/724,911, filed on Nov. 26, 2024. The content of the application is incorporated herein by reference.

### BACKGROUND OF THE INVENTION

### 1. Field of the Invention

The present invention relates to a method for a display driver circuit, and more particularly, to a power reduction scheme for a display driver circuit.

### 2. Description of the Prior Art

While advanced semiconductor processes offer advantages in dynamic power consumption, they are often accompanied by the drawback of increased device leakage currents. To reduce overall power consumption, display devices typically switch to a low frame rate mode in various application scenarios. However, when the frame rate is reduced to lower dynamic power consumption, the static power caused by the leakage currents becomes the dominant factor in total power consumption of the display system.

### SUMMARY OF THE INVENTION

It is therefore an objective of the present invention to provide a method for a display driver circuit, to reduce overall power consumption in the low frame rate mode by detecting the operational behavior of the high-speed interface.

An embodiment of the present invention discloses a method for a display driver circuit. The method comprises steps of: receiving display data through a display interface; detecting whether the display driver circuit enters a non-active state in which the display driver circuit stops refreshing a display panel; and in response to detecting that the display driver circuit enters the non-active state, configuring a power supply state for an internal circuit of the display driver circuit to save power consumption of the internal circuit.

Another embodiment of the present invention discloses a display driver circuit, which comprises a receiver, a detector and a power control circuit. The receiver is configured to receive display data through a display interface. The detector is configured to detect whether the display driver circuit enters a non-active state in which the display driver circuit stops refreshing a display panel. The power control circuit, coupled to the detector, is configured to configure a power supply state for an internal circuit of the display driver circuit in response to detecting that the display driver circuit enters the non-active state, to save power consumption of the internal circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIG. 2 is a flowchart of a power control process according to an embodiment of the present invention.

FIG. 3 illustrates that the detector detects the display state by detecting the operation mode of a display interface complying with eDP according to an embodiment of the present invention.

FIG. 4 illustrates that the detector detects the display state by detecting the operation mode of another display interface complying with MIPI according to an embodiment of the present invention.

FIG. 5 illustrates that the detector detects the display state by counting based on a frame rate switch command according to an embodiment of the present invention.

FIG. 6 illustrates that the display driver circuit receives a preconfigured signal indicating the display state from the host.

FIG. 7 illustrates that the detector changes the level of the power control signal earlier by using a counter before the display driver circuit enters the active state.

FIG. 8 to FIG. 11 illustrate that the detector monitors the display state for a period by using another counter.

FIG. 12A and FIG. 12B are schematic diagrams illustrating the operations of an internal circuit controlled by a power control circuit according to embodiments of the present invention.

FIG. 13A and FIG. 13B illustrate implementations of the power control circuit according to embodiments of the present invention.

FIG. 14A and FIG. 14B are schematic diagrams illustrating the operations of an internal circuit controlled by a power control circuit according to embodiments of the present invention.

FIG. 15A and FIG. 15B illustrate implementations of the power control circuit according to embodiments of the present invention.

FIG. 16 illustrates another implementation of the power control circuit shown in FIG. 14A according to an embodiment of the present invention.

FIG. 17 illustrates a further implementation of the power control circuit shown in FIG. 14A according to an embodiment of the present invention.

### DETAILED DESCRIPTION

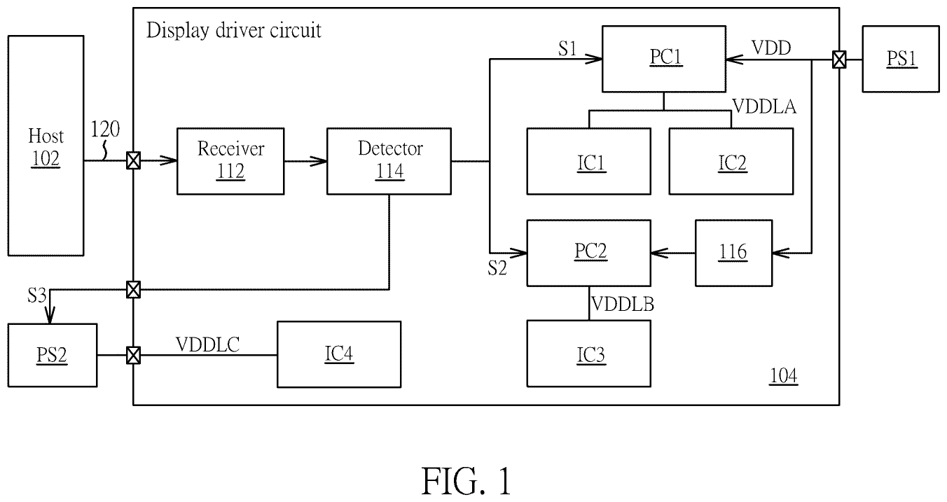

FIG. 1 is a schematic diagram of a display system 10 according to an embodiment of the present invention. The display system 10 includes a host 102 and a display driver circuit 104. The host 102 may serve as a video source, for generating and providing image data to be displayed. Examples of the host 102 may include, but not limited to, a central processing unit (CPU) and an application processor (AP). The display driver circuit 104 may be a circuit device capable of driving a display panel (omitted in FIG. 1 for brevity) to display. In one or some embodiments, the display driver circuit 104 may be implemented in a chip, as a display driver integrated circuit (DDIC).

As shown in FIG. 1, the display driver circuit 104 is operated by receiving power from external power supply devices PS1 and PS2. In detail, the power supply device PS1 outputs a supply voltage VDD to the display driver circuit 104, and the power supply device PS2 outputs another supply voltage VDDLC to the display driver circuit 104. Each of the power supply devices PS1 and PS2 may be implemented using a power management integrated circuit (PMIC), but not limited thereto.

The display driver circuit 104 includes a receiver 112, a detector 114, a voltage generator 116, power control circuits PC1 and PC2, and internal circuits IC1-IC4. The internal circuits IC1-IC4 may be or include various circuit blocks or circuit modules, such as an image processing circuit, compensation circuit and display driving channels, but not limited thereto. These internal circuits IC1-IC4 may operate by receiving respective supply voltages. In this embodiment, the internal circuits IC1 and IC2 receive a supply voltage VDDLA from the power control circuit PC1, the internal circuit IC3 receives a supply voltage VDDLB from the power control circuit PC2, and the internal circuit IC4 receives a supply voltage VDDLC from the external power supply device PS2.

The power control circuits PC1 and PC2 are configured to control power supply for the corresponding internal circuits. In this embodiment, the power control circuit PC1 configures the power supply state for the internal circuits IC1 and IC2 by outputting the supply voltage VDDLA, and the power control circuit PC2 configures the power supply state for the internal circuit IC3 by outputting the supply voltage VDDLB. The voltage generator 116 is coupled between the power supply device PS1 and the power control circuit PC2, for converting the supply voltage VDD into a desired output voltage to be provided for the power control circuit PC2 and the internal circuit IC3 (e.g., as the supply voltage VDDLB). The power control circuit PC1 may convert the supply voltage VDD into the supply voltage VDDLA. In some embodiments, the power control circuit PC1 may include a similar voltage generator capable of generating and outputting the supply voltage VDDLA. Examples of the voltage generator 116 include a low-dropout regulator (LDO) and switching regulator, but not limited thereto.

In order to forward display data, the host 102 and the display driver circuit 104 are coupled through a display interface 120 complying with an interface standard such as the Mobile Industry Processor Interface (MIPI), Display Port (DP), embedded Display Port (eDP), or Serial Peripheral Interface (SPI). Therefore, the receiver 112 may be or include a receiving circuit capable of receiving the display data through the display interface 120 based on the interface standard. The detector 114 may detect the receiving behavior of the receiver 112 and/or monitor the operation state of the display interface 120, thereby determining the operation mode of display. Alternatively or additionally, the receiver 112 is configured to receive an indication signal from the host 102 through the display interface 120 or another interface, where the indication signal indicates an operation mode. The operation mode will be discussed in more detail in the following paragraphs.

In the embodiments of the present invention, the display system 10 is allowed to dynamically control the display frame rate. For example, the display driver circuit 104 may refresh the display panel with a higher frame rate when the display panel needs to display videos, while refreshing the display panel with a lower frame rate to reduce power consumption when the display panel displays static images. However, as mentioned above, although the power consumption is reduced by decreasing the frame rate and reducing the data transmission through the display interface 120, the internal circuits IC1-IC4 still consume inescapable static power. To solve this problem, based on the detected operation mode of display, the detector 114 may provide power control signals S1-S3 to the power control circuits PC1 and PC2 and the power supply device PS2, to adjust the power supply state of the internal circuits IC1-IC4, thereby saving the static power consumption of the internal circuits IC1-IC4.

Note that the structure shown in FIG. 1 serves to illustrate various possible scenarios of power control for the internal circuit. For example, a power control circuit may be configured to control only one internal circuit (such as the power control circuit PC2), or control two or more internal circuits (such as the power control circuit PC1). In addition, a power control circuit may forward internal power supplied from a voltage generator to the internal circuit (such as the power control circuit PC2), or may directly convert external power to be supplied to the internal circuit (such as the power control circuit PC1). Further, an internal circuit may receive power from an internal power control circuit of the display driver circuit (such as the internal circuits IC1-IC3), or may receive power from an external power supply device (such as the internal circuit IC4).

Also note that the structure shown in FIG. 1 is merely an exemplary implementation of the display driver circuit 104. In the embodiments of the present invention, the display driver circuit may be designed to have any number of internal circuit(s) receiving power supply control in any appropriate manner. In such a situation, there may be any number of power control circuit(s) used for controlling the internal circuit(s), and the display driver circuit may receive power supply from any number of external power supply device(s).

For example, in the embodiment shown in FIG. 1, there are four internal circuits IC1-IC4 and two power control circuits PC1-PC2 included in the display driver circuit 104, and these circuits may coexist in a display driver circuit. In another embodiment, a display driver circuit may include only one or some of the internal circuits IC1-IC4. For example, in an embodiment, the display driver circuit only includes the internal circuit IC4 and the corresponding power supply device PS2, while other internal circuits and power circuits are omitted. In an embodiment, the display driver circuit only includes the internal circuit IC1 and the corresponding power control circuit PC1 and power supply device PS1, while other internal circuits and power circuits are omitted. In fact, the internal circuits and the power control circuits may be arranged in any appropriate manner, and the related implementations should not serve to limit the scope of the present invention.

In addition, in the display driver circuit 104 shown in FIG. 1, each of the power control circuits PC1 and PC2 and the power supply device PS2 receives a respective power control signal S1-S3. In another embodiment, multiple power control circuits and/or power supply devices may provide power supply configurations by receiving the same power control signal. This is because the power control signals are generated based on the display state of the display driver circuit 104 and/or the display interface 120, and different power control signals in the same display driver circuit may usually have the same switching behavior.

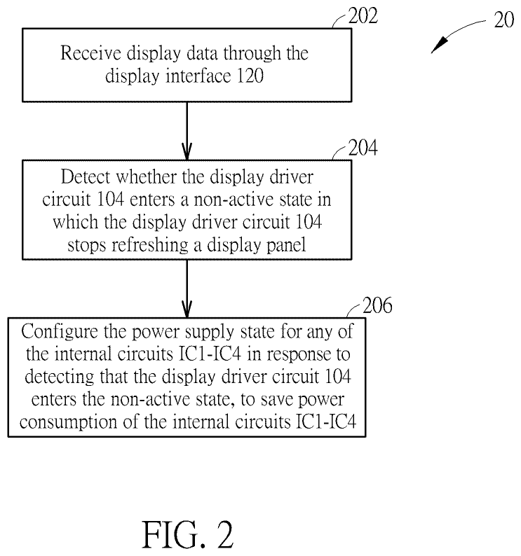

FIG. 2 is a flowchart of a power control process 20 according to an embodiment of the present invention. The power control process 20 may be implemented in a display driver circuit, such as the display driver circuit 104 shown in FIG. 1. As shown in FIG. 2, the power control process 20 includes the following steps:

Step 202: receive display data through the display interface 120.

Step 204: Detect whether the display driver circuit 104 enters a non-active state in which the display driver circuit 104 stops refreshing a display panel.

Step 206: Configure the power supply state for any of the internal circuits IC1-IC4 in response to detecting that the display driver circuit 104 enters the non-active state, to save power consumption of the internal circuits IC1-IC4.

According to the power control process 20, the receiver 112 may receive display data from the host 102 through the display interface 120 (Step 202). Based on the dynamic frame rate control, each frame period for receiving the display data may be classified into an active period and a non-active period, where the display data are delivered through the display interface 120 in the active period only. The host 102 may dynamically allocate the active period and the non-active period which has a variable length in one frame period to achieve the desired frame rate. In the active period, the display driver circuit 104 may operate in an active state to refresh the display panel by receiving the display data. In the non-active period, the display driver circuit 104 may operate in a non-active state to stop refreshing the display panel, where the reception of the display data through the display interface 120 may also stop.

In another embodiment, the active period and the non-active period may be arranged by using a long-V approach. In this manner, the non-active period may be provided by extending the vertical front/back porch or blanking period, thereby adjusting the length of the non-active period to control the frame rate dynamically.

No matter how the active period and the non-active period are arranged, the detector 114 may detect whether the display driver circuit 104 enters the non-active state (Step 204) and outputs the power control signals S1-S3 accordingly. Based on the corresponding power control signal(s), the power control circuit PC1, PC2 and/or the power supply device PS2 may configure the power supply state of the internal circuits IC1-IC4. For example, if the display driver circuit 104 is in the active state, the internal circuits IC1-IC4 may be configured to be in a normal power supply state; if the display driver circuit 104 enters the non-active state, the internal circuits IC1-IC4 may be configured to be in a low power supply state. In order to save power consumption, the power control circuit PC1, PC2 and/or the power supply device PS2 may dynamically reduce the supply voltages or even cut off the power supply for the corresponding internal circuits IC1-IC4 when the display driver circuit 104 enters the non-active state.

The detector 114 may determine the power supply state of the internal circuits IC1-IC4 by detecting the operation mode of the display interface 120, and the detection may be performed in any appropriate manner. For example, in an embodiment, the detector 114 may detect whether the display interface 120 transits from a normal operation mode to a sleep mode or low-power mode, thereby determining whether to adjust the power supply state of the internal circuits IC1-IC4.

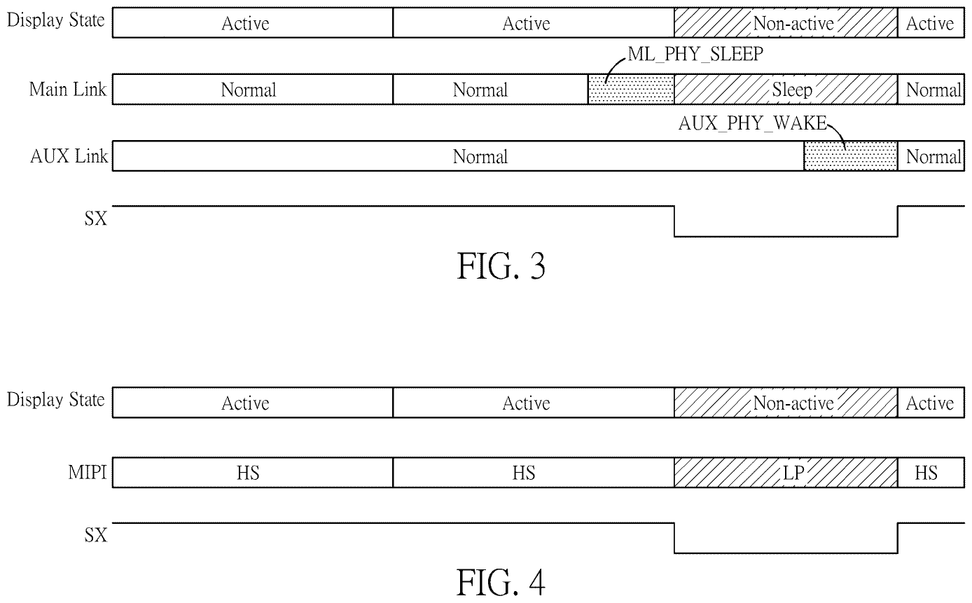

FIG. 3 illustrates that the detector 114 detects the display state by detecting the operation mode of the display interface 120 according to an embodiment of the present invention. In this embodiment, the display interface 120 complying with eDP is taken as an example. As shown in FIG. 3, the display interface 120 includes a main link and an auxiliary link. In addition, FIG. 3 also shows the display state of the display driver circuit 104 and the waveform of a power control signal SX (which may be any of S1-S3).

According to the behavior shown in FIG. 3, in the beginning both of the main link and the auxiliary link of the display interface 120 are in the normal operation mode, so that the display driver circuit 104 is in the active state, where the display data are sent from the host 102 to the display driver circuit 104 normally. Subsequently, when the host 102 sends a sleep indicating packet ML_PHY_SLEEP through the main link to indicate that the display interface 120 is going to enter the sleep mode, the display driver circuit 104 enters the non-active state correspondingly. In response to receiving the sleep indicating packet ML_PHY_SLEEP, the receiver 112 of the display driver circuit 104 may enter the sleep mode, and the main link may also transit to the sleep mode, to save power consumption. At this time, the power control signal SX output by the detector 114 may be pulled low, thereby controlling the corresponding internal circuit to enter the low power supply state.

In the next frame period, the host 102 sends a wakeup indicating packet AUX_PHY_WAKE through the auxiliary link to indicate that the display interface 120 transits to the normal mode, so that the display driver circuit 104 returns to the active state to transmit display data normally. Subsequently, the main link returns to the normal operation mode and the receiver 112 of the display driver circuit 104 restarts to operate normally. At this time, the power control signal SX output by the detector 114 may be pulled high, thereby controlling the corresponding internal circuit to enter the normal power supply state.

In this embodiment, the internal circuit enters the low power supply state when the power control signal goes low, and enters the normal power supply state when the power control signal goes high. Those skilled in the art would know that this implementation is merely an example, and the power supply state of the internal circuit may be indicated by any logic level or state of the power control signal. In fact, the power control signal may be implemented in any appropriate manner, such as a digital signal, analog signal, and/or flag, which should not be limited to those described in this disclosure.

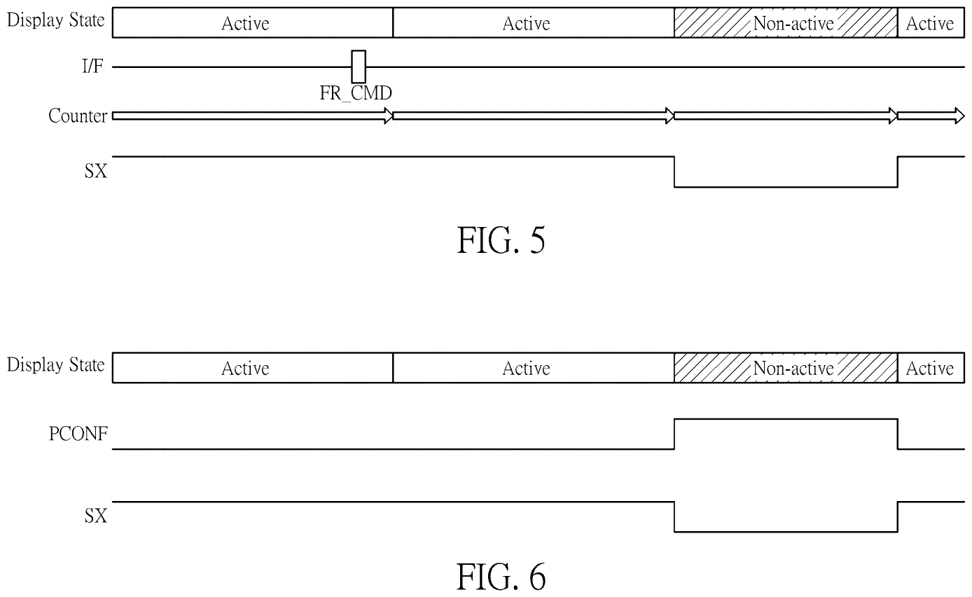

The data transmission operations and related packets provided in FIG. 3 are used for the display interface 120 complying with eDP. In another embodiment, another interface standard is applicable. For example, FIG. 4 illustrates another embodiment where the display interface 120 complies with MIPI. As shown in FIG. 4, in the beginning the display interface 120 is in the high-speed (HS) mode to deliver the display data, so that the display driver circuit 104 is in the active state. Subsequently, the host 102 controls the display interface 120 to transit from the high-speed mode to a low power (LP) mode, and the display driver circuit 104 enters the non-active state correspondingly. At this time, the receiver 112 of the display driver circuit 104 may enter the sleep mode, and the power control signal SX output by the detector 114 may be pulled low, thereby controlling the corresponding internal circuit to enter the low power supply state.

In the next frame period, the host 102 controls the display interface 120 to return to the high-speed mode, so that the display driver circuit 104 returns to the active state to transmit display data normally. In response, the receiver 112 may restart to operate normally, and the power control signal SX output by the detector 114 may be pulled high, thereby controlling the corresponding internal circuit to enter the normal power supply state.

In another embodiment, the host 102 may provide a frame rate switch command to the display driver circuit 104, where the frame rate switch command may indicate the rule of frame rate changes.

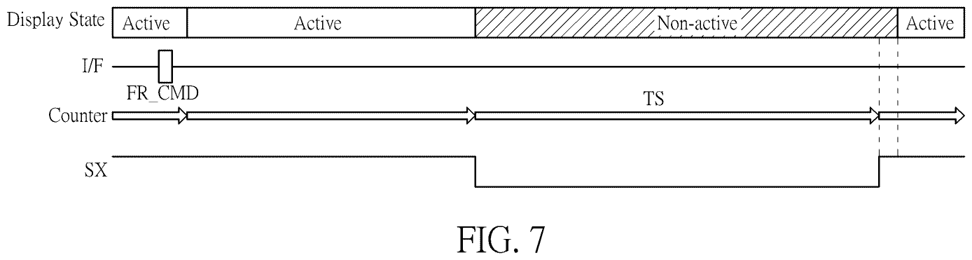

FIG. 5 illustrates that the detector 114 detects the display state by counting based on a frame rate switch command FR_CMD according to an embodiment of the present invention. This embodiment is applicable to a display interface with any interface standard, such as the MIPI, eDP or SPI, but not limited thereto. As shown in FIG. 5, the host 102 sends the frame rate switch command FR_CMD to the display driver circuit 104 through an interface (I/F). This interface may refer to the display interface 120 through which the host 102 transmits display data to the display driver circuit 104, or any other transmission interface utilized by the host 102 to send the command(s) required by the display driver circuit 104.

In one or some embodiments, the frame rate switch command FR_CMD may carry information indicating the rule of frame rate transition in subsequent frame periods. For example, the frame rate switch command FR_CMD may indicate that an upcoming frame rate will be 60 Hz while the current frame rate is 120 Hz; hence, by receiving the frame rate switch command FR_CMD and using the counter, the display driver circuit 104 may know when to allocate the active period and the non-active period of the first frame period after changing to the upcoming frame rate. In this embodiment, the detector 114 may be configured with a counter to count the length of the active period and/or the length of the non-active period which may be defined by a configured frame rate informed by the frame rate switch command FR_CMD, thereby the display driver circuit 104 determines when to change the level of the power control signal SX. If the frame rate switch command FR_CMD is sent through a display interface, it may be sent in a suitable blanking period, where the time of sending the command is not limited.

In other words, the counter may count a period during which the display driver circuit 104 stays in the active state, thereby determining the start time of the non-active state after the end of the active state. Alternatively or additionally, the counter may count a period during which the display driver circuit 104 stays in the non-active state, thereby determining the end time of the present non-active state. In such a situation, the detector 114 may detect whether the display driver circuit 104 enters the non-active state through the counter's counting behavior, thereby changing the level of the power control signal SX to adjust the power supply state of the internal circuit in the non-active state.

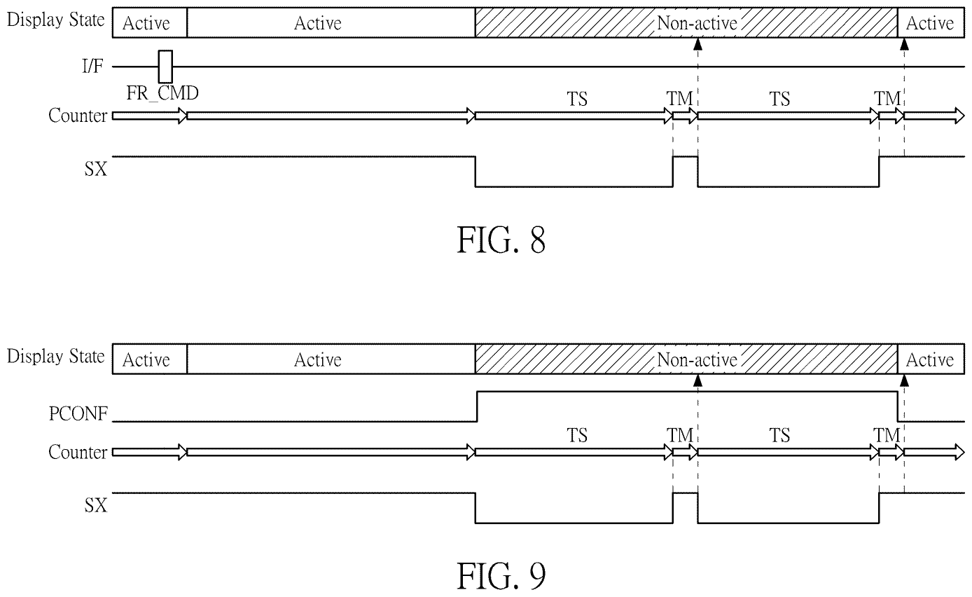

In another embodiment, the display driver circuit 104 may directly receive a preconfigured signal PCONF indicating the display state from the host 102. For example, as shown in FIG. 6, the preconfigured signal PCONF with the first logic level (e.g., logic “low”) is corresponding to the active state, and the preconfigured signal PCONF with the second logic level (e.g., logic “high”) is corresponding to the non-active state. Therefore, the detector 114 may detect whether the preconfigured signal PCONF transits from “low” to “high”, to determine whether the display driver circuit 104 enters the non-active state.

In the embodiment where the non-active state is indicated by the preconfigured signal PCONF sent by the host 102, the preconfigured signal PCONF may be sent through any interface such as a general purpose input/output (GPIO) pin. The GPIO pin may be an interface independent of the display interface that used to send the display data, and thus the display interface may be of any protocol.

In some embodiments, after the power supply for a specific internal circuit is cut off in the non-active state, when the power supply is recovered at the end of the non-active state, this internal circuit might not be able to immediately operate normally to process display data. In other words, the internal circuit requires a startup time before it is ready for normal operations. In such a situation, the power supply should be restarted with a predetermined period before the end of the non-active state; hence, the power control signal SX should return to the level corresponding to the active state with an advance time. This allows the internal circuit to return to the normal power supply state from the low power supply state before the display driver circuit enters the active state.

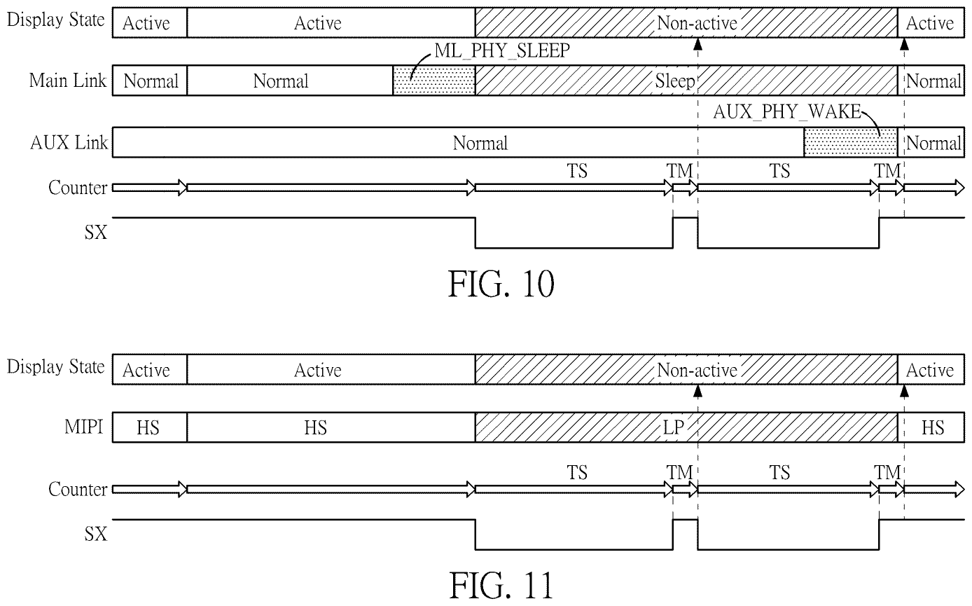

FIG. 7 illustrates that the detector 114 changes the level of the power control signal SX earlier before the display driver circuit 104 enters the active state. As shown in FIG. 7, the power control signal SX at a logic “high” level provides the normal power supply state for active display data transmission and processing, and at a logic “low” level provides the low power supply state to be used in the non-active period. In this embodiment, the advanced power control is achieved by using a counter. The counter may start counting in response to the detector 114 detecting that the display driver circuit 104 enters the non-active state, with a counting period TS less than the overall period in which the display driver circuit 104 stays in the non-active state. In response to the expiration of the counter, the power control signal SX goes “high” to instruct the power control circuit to control the corresponding internal circuit to exit the low power supply state. Therefore, the internal circuit may return to the normal power supply state and start the initialization or power-on procedure, to be ready for normal operation at the start of the next active state of the display driver circuit 104.

In the embodiment shown in FIG. 7, the display driver circuit 104 is informed of the end time of the non-active state (e.g., through the frame rate switch command FR_CMD), and thus it is feasible to start the normal power supply state before the end time of the non-active state. In another embodiment, the display driver circuit 104 may not know when it will be switched to the active state from the non-active state. Therefore, the counter for non-active state detection may be configured with an appropriate expiration time. When the counter expires, the power control circuit may wake up the internal circuit, while the detector 114 still monitors the display state for a period of time, to determine whether the display driver circuit 104 has returned to the active state. If not, the power control circuit may further control the internal circuit by providing the low power supply state again.

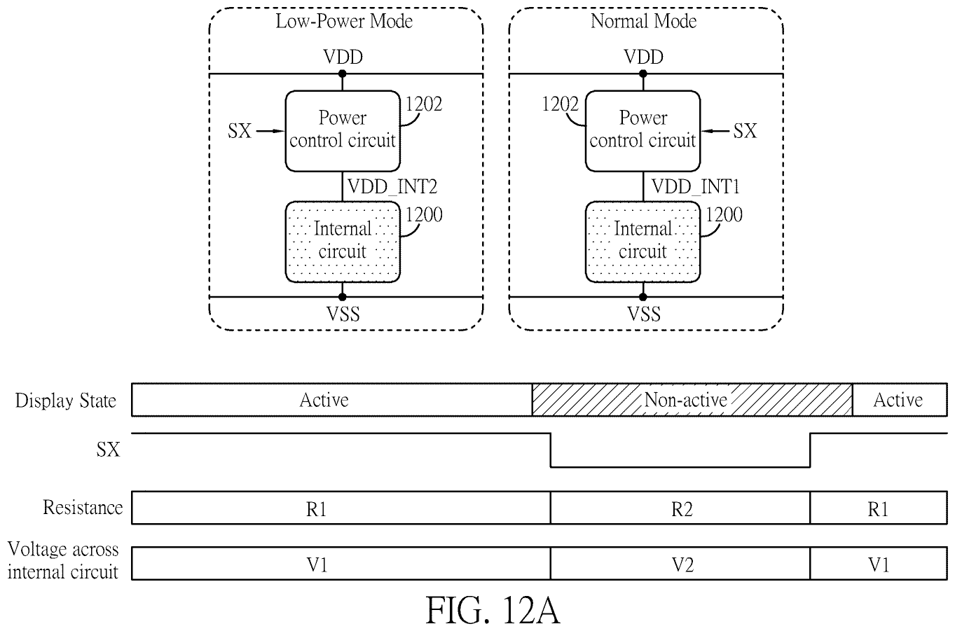

The operations may be achieved by using another counter. For example, as another embodiment shown in FIG. 8, at the time when the display driver circuit 104 enters the non-active state, the power control signal SX goes “low” to configure the internal circuit with the low power supply state, and at this time, a first counter starts to count a predetermined period TS. As the first counter expires, the power control signal SX goes “high” to control the internal circuit to enter the normal power supply state, and at this time, a second counter (or the same first counter) starts counting another period TM, and the detector 114 may keep monitoring the display state to determine whether the display driver circuit 104 returns to the active state. At the expiration of the second counter (i.e., at the end of the counting period TM), if the detector 114 detects that the display driver circuit 104 still stays in the non-active state, the power control signal SX goes “low” again, allowing the power control circuit to stop providing normal power supply and configure the internal circuit to enter the low power supply state again.

Subsequently, the display driver circuit 104 will repeat similar counter operations by counting a period TS for keeping the low power supply state and then counting another period TM for detecting whether the display state returns to active. When the detector 114 detects that the display driver circuit 104 enters the active state, the power control circuit will keep the normal power supply state of the internal circuit, and the counter continues to count for subsequent active state(s).

The lengths of the periods TS and TM may be set to any suitable values. In addition, the period TM may be set based on the startup time or power-on time required by the internal circuit. Therefore, when the display driver circuit 104 is switched to the active state from the non-active state, the internal circuit is powered on completely and ready to operate normally.

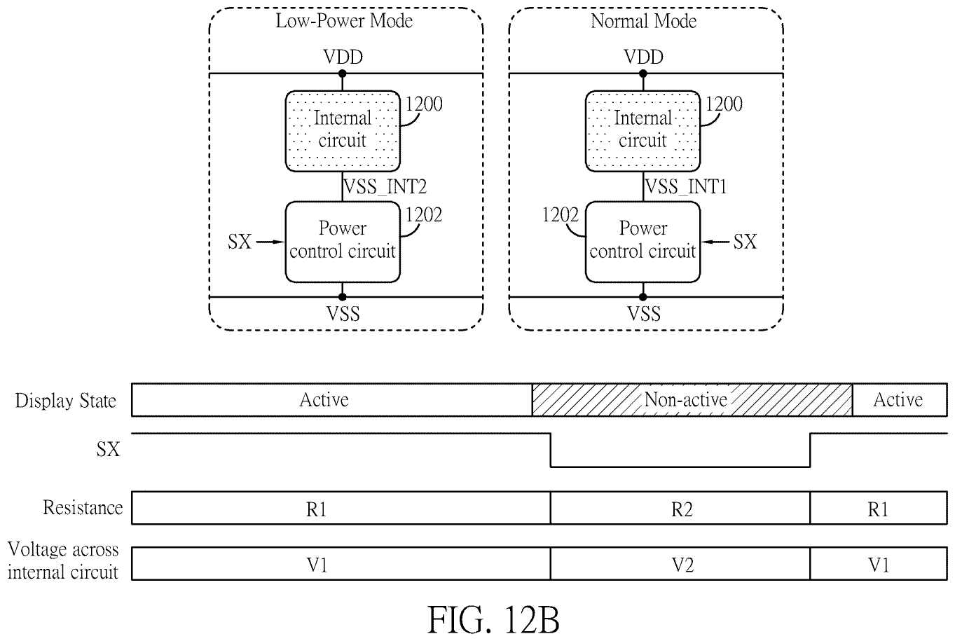

Note that the operations of using one or more counters to try to activate the internal circuit after the expiration of the predetermined period TS are applicable to different scenarios of display state indications. In another embodiment shown in FIG. 9, the display driver circuit 104 may obtain this information by receiving the preconfigured signal PCONF, and the preconfigured signal PCONF may be sent through a GPIO pin. Similar counting operations are performed by one or more counters set up with the periods TS and TM.

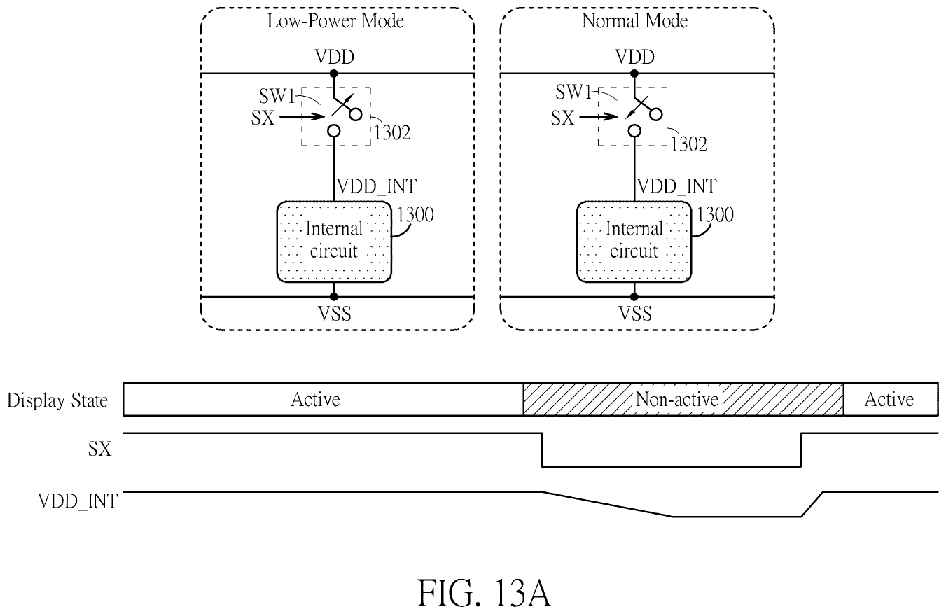

In another embodiment shown in FIG. 10, the display driver circuit 104 may receive display data from the host 102 through the display interface 120 complying with eDP, where the counting operation for waking up the internal circuit before the end of the non-active state is also feasible. As shown in FIG. 10, when the main link enters the sleep mode in response to the sleep indicating packet ML_PHY_SLEEP, the counter starts to count the period TS and it is followed by another counter counting the period TM. The detailed operations of the counters are similar to those described above, and will be omitted herein.

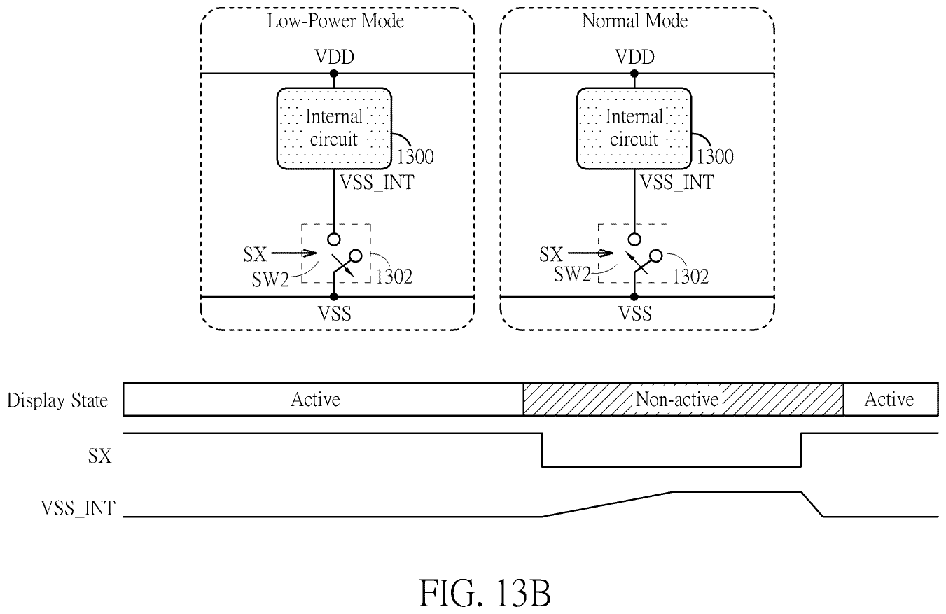

In another embodiment shown in FIG. 11, the display driver circuit 104 may receive display data from the host 102 through the display interface 120 complying with MIPI, where the counting operation for waking up the internal circuit before the end of the non-active state is also feasible. As shown in FIG. 11, when the interface transits to the low-power mode, the counter starts to count the period TS and it is followed by another counter counting the period TM. The detailed operations of the counters are similar to those described above, and will be omitted herein.

Note that the present invention aims at providing a power reduction scheme for reducing static power consumption of internal circuits in a display driver circuit when the display driver circuit enters the non-active state where the display driver circuit stops receiving display data and refreshing the display panel. The above embodiments introduce several detection methods for determining whether and when the display driver circuit enters the non-active state and/or returns to the active state. In addition, the present invention further provides some methods for controlling the power supply state of the internal circuit to reduce power consumption.

A display driver circuit may include various types of internal circuits. Some internal circuits could be fully turned off when no display data needs to be processed, and thus the power supply for these internal circuits may be cut off when the display driver circuit enters the non-active state. Some internal circuits could not be fully turned off but operate in a low-power mode, and thus these internal circuits may operate by receiving a lower supply voltage and/or current when the display driver circuit enters the non-active state. As mentioned above, the detector 114 may detect the display state of the display driver circuit 104, and output the power control signal SX to the power control circuit (or the power supply device) according to whether the display driver circuit 104 is in the non-active state. In an embodiment, the power control signal SX may be a 1-bit signal. If the display driver circuit 104 is in the active state, the power control signal SX may be in a first state to control the power control circuit (or the power supply device) to provide a normal supply voltage to the internal circuit. If the display driver circuit 104 enters the non-active state, the power control signal SX may be in a second state to control the power control circuit (or the power supply device) to provide another power supply state, where the power control circuit (or the power supply device) may supply a lower supply voltage to the internal circuit or even cut off the power supply for the internal circuit.

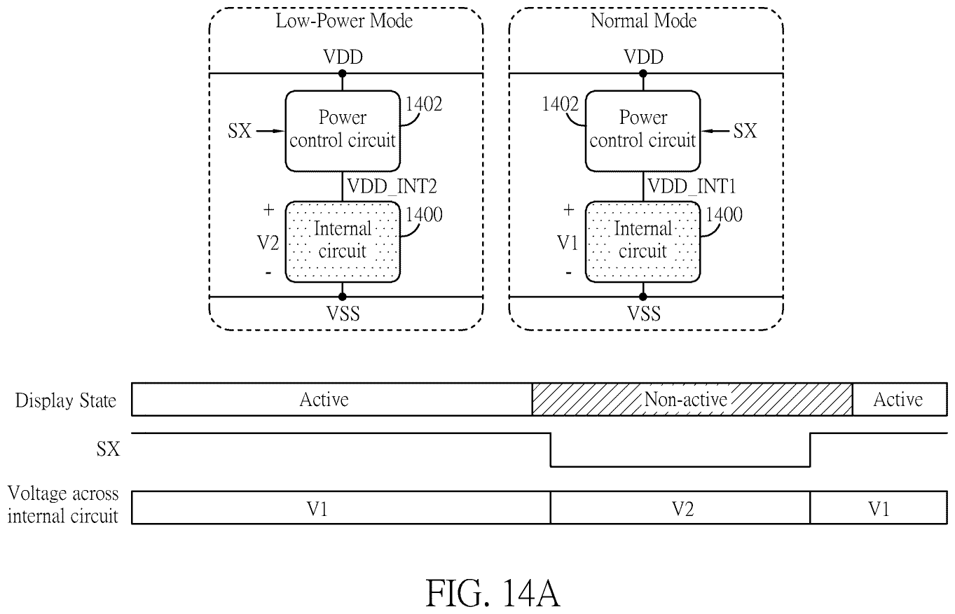

FIG. 12A is a schematic diagram illustrating the operations of an internal circuit 1200 controlled by a power control circuit 1202 according to an embodiment of the present invention, where the power control circuit 1202 may operate in a normal mode or a low-power mode according to the power control signal SX received from a detector. The power control circuit 1202 may receive a supply voltage VDD from a voltage supply source, and correspondingly supply an internal supply voltage that is lower than the supply voltage VDD to the internal circuit 1200. In this embodiment, when the display driver circuit is in the active state, the power control signal SX is at a logic “high” level to control the power control circuit 1202 to operate in the normal mode, which thereby configures the internal circuit 1200 to be in the normal power supply state. Conversely, when the display driver circuit is in the non-active state, the power control signal SX is at a logic “low” level to control the power control circuit 1202 to operate in the low-power mode, which thereby configures the internal circuit 1200 to be in the low power supply state.

Note that the transition of the power control signal SX may be exactly synchronous with the switching between the active state and the non-active state as in some embodiments described above, or they may have a small delay or ahead of time as shown in FIG. 12A, e.g., for waking up the internal circuit earlier. As long as the power control signal SX has a voltage level (or digital value) corresponding to the active state and a different voltage level (or different digital value) corresponding to the non-active state, the related implementations should belong to the scope of the present invention.

In this embodiment, the power control circuit 1202 may include or control a variable resistance circuit, which is disposed between the voltage supply source that supplies the supply voltage VDD and the internal circuit 1200. When the detector detects that the display driver circuit enters the active state, the power control circuit 1202 may operate in the normal mode, where the power control signal SX controls the variable resistance circuit to generate a resistance R1 such that the power control circuit 1202 supplies an internal supply voltage VDD_INT1 to the internal circuit 1200. When the detector detects that the display driver circuit enters the non-active state, the power control circuit 1202 may operate in the low-power mode, where the power control signal SX controls the variable resistance circuit to generate a resistance R2 which is greater than the resistance R1 such that the power control circuit 1202 supplies an internal supply voltage VDD_INT2 lower than the internal supply voltage VDD_INT1 to the internal circuit 1200.

In another embodiment shown in FIG. 12B, the variable resistance circuit of the power control circuit 1202 may be disposed between another voltage supply source that supplies the supply voltage VSS (which may be a negative voltage or ground voltage) and the internal circuit 1200 and the power control circuit 1202 is controlled by the power control signal SX in a similar way of FIG. 12A. In the normal mode, the power control signal SX controls the variable resistance circuit to generate a resistance R1 such that the power control circuit 1202 supplies an internal supply voltage VSS_INT1 to the internal circuit 1200. In the low-power mode, the power control signal SX controls the variable resistance circuit to generate a resistance R2 which is greater than the resistance R1 such that the power control circuit 1202 supplies an internal supply voltage VSS_INT2 higher than the internal supply voltage VSS_INT1 to the internal circuit 1200. By using the way of FIG. 12A or FIG. 12B, an across voltage V2 of the internal circuit 1200 in the low-power mode is controlled to be smaller than an across voltage V1 of the internal circuit 1200 in the normal mode, and the power consumption of the internal circuit 1200 is reduced.

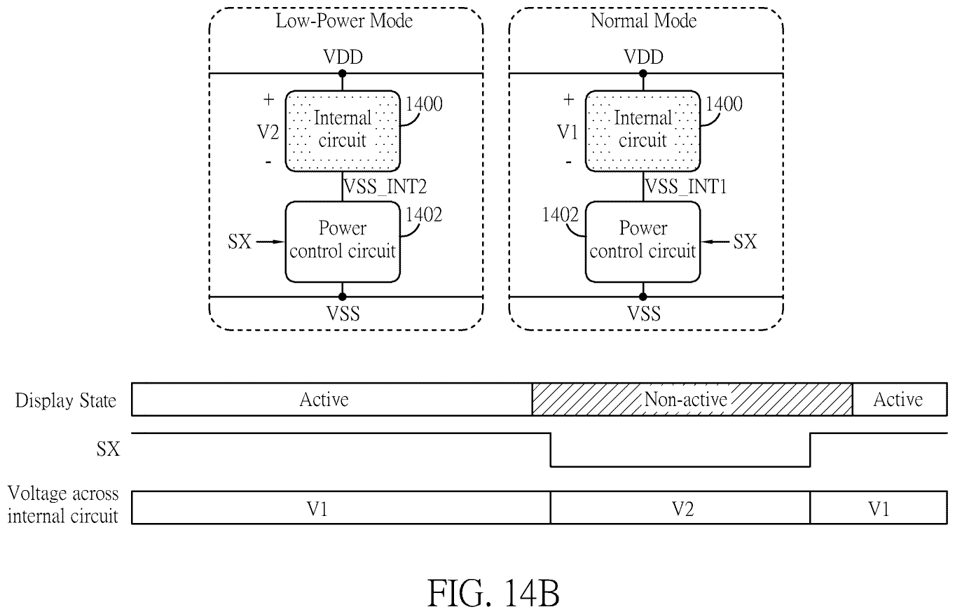

The reduction of power consumption may be realized in any manner. FIG. 13A illustrates an implementation of the power control circuit according to an embodiment of the present invention. A power control circuit 1302 includes a switch SW1 controlled by the power control signal SX. When the detector detects that the display driver circuit enters the active state, the power control circuit 1302 operates in the normal mode, where the power control signal SX turns on the switch SW1 to conduct the supply voltage VDD as the internal supply voltage VDD_INT to be supplied to an internal circuit 1300. When the detector detects that the display driver circuit enters the non-active state, the power control circuit 1302 operates in the low-power mode, where the power control signal SX turns off the switch SW1 to disconnect the voltage supply source from the internal circuit 1300, i.e., cutting off the path of supplying the supply voltage VDD to the internal circuit 1300. As shown in FIG. 13A, the voltage level of the internal supply voltage VDD_INT decreases when the switch SW1 is cut off.

FIG. 13B illustrates another implementation of the power control circuit according to an embodiment of the present invention. In this embodiment, the power control circuit 1302 is disposed between the voltage supply source providing the supply voltage VSS and the internal circuit 1300, and includes a switch SW2. Through the control of the power control signal SX, the switch SW2 may be turned on when the power control circuit 1302 operates in the normal mode and turned off when the power control circuit 1302 operates in the low-power mode. Therefore, the path of supplying the supply voltage VSS is cut off in the low-power mode. The voltage level of the internal supply voltage VSS_INT increases when the switch SW2 is cut off. Therefore, static power consumption of the internal circuit 1300 is reduced when the display driver circuit is in the non-active state.

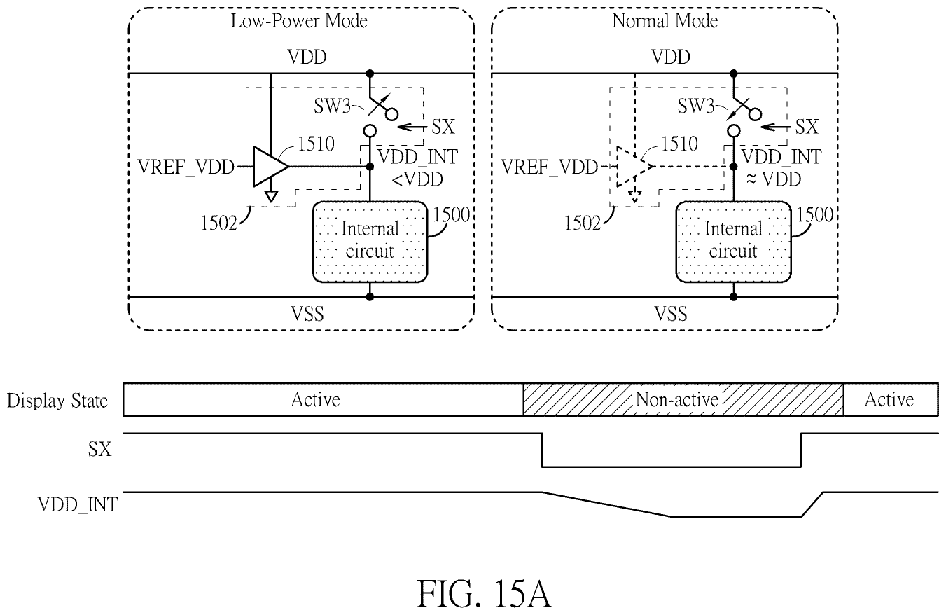

In other embodiments, the power control circuit in the low-power mode may provide a lower voltage for the internal circuit instead of cutting off the power supply. FIG. 14A is a schematic diagram illustrating the operations of an internal circuit 1400 controlled by a power control circuit 1402 according to an embodiment of the present invention. Similarly, the power control circuit 1402 may operate in a normal mode or a low-power mode according to the power control signal SX received from a detector. The control schemes are similar to those described above, and will not be narrated herein.

In this embodiment, the power control circuit 1402 is able to adjust the voltage across the internal circuit 1400 under different operation modes. When the detector detects that the display driver circuit enters the active state, the power control circuit 1402 may operate in the normal mode to supply a higher internal supply voltage VDD_INT1, thereby providing a larger voltage V1 across the internal circuit 1400. When the detector detects that the display driver circuit enters the non-active state, the power control circuit 1402 may operate in the low-power mode to supply a lower internal supply voltage VDD_INT2, thereby providing a smaller voltage V2 across the internal circuit 1400, where V2 is lower than V1.

In general, the power consumption of an internal circuit is proportional to the voltage across the internal circuit. Therefore, the smaller voltage V2 across the internal circuit 1400 is helpful in reducing the power consumption of the internal circuit 1400.

In another embodiment shown in FIG. 14B, the power control circuit 1402 may be disposed between another voltage supply source that supplies the supply voltage VSS (which may be a negative voltage or ground voltage) and the internal circuit 1400. In such a situation, the power control circuit 1402 operating in the normal mode may supply a lower internal supply voltage VSS_INT1, thereby providing a larger voltage V1 across the internal circuit 1400. The power control circuit 1402 operating in the low-power mode may supply a higher internal supply voltage VSS_INT2, thereby providing a smaller voltage V2 across the internal circuit 1400.

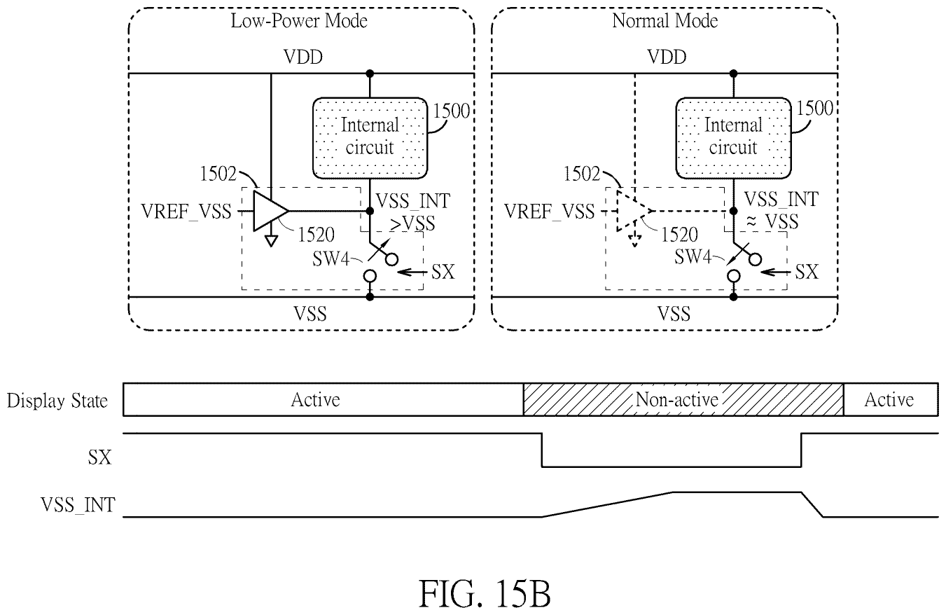

FIG. 15A illustrates a power control circuit 1502, which is an implementation of the power control circuit 1402 shown in FIG. 14A according to an embodiment of the present invention. The power control circuit 1502 includes a switch SW3 and a voltage generator 1510. The switch SW3 is controlled by the power control signal SX. The voltage generator 1510 is configured to generate the internal supply voltage VDD_INT according to a reference voltage VREF_VDD, and output the internal supply voltage VDD_INT to an internal circuit 1500.

When the power control circuit 1502 operates in the normal mode, the switch SW3 may be turned on to conduct the supply voltage VDD as the internal supply voltage VDD_INT to be supplied to the internal circuit 1500. In other words, the internal supply voltage VDD_INT is substantially equal to VDD. When the power control circuit 1502 operates in the low-power mode, the switch SW3 may be turned off to disconnect the voltage supply source from the internal circuit 1500, i.e., cutting off the path of supplying the supply voltage VDD. At this time, the voltage generator 1510 may output the internal supply voltage VDD_INT to the internal circuit 1500. The internal supply voltage VDD_INT provided by the voltage generator 1510 is set to be lower than VDD, thereby reducing static power consumption of the internal circuit 1500 when the display driver circuit is in the non-active state.

FIG. 15B illustrates another implementation of the power control circuit 1402 shown in FIG. 14B according to an embodiment of the present invention. In this embodiment, a power control circuit 1502 is disposed between the voltage supply source providing the supply voltage VSS and the internal circuit 1500, and includes a switch SW4 and a voltage generator 1520. Through the control of the power control signal SX, the switch SW4 may be turned on when the power control circuit 1502 operates in the normal mode and turned off when the power control circuit 1502 operates in the low-power mode, i.e., the path of supplying the supply voltage VSS is cut off in the low-power mode. In such a situation, the internal supply voltage VSS_INT will be supplied by the voltage generator 1520 instead, and the level of the internal supply voltage VSS_INT may be higher than the supply voltage VSS, as could be achieved by setting the reference voltage VREF_VSS appropriately. This will also decrease the voltage across the internal circuit 1500, thereby reducing static power consumption of the internal circuit 1500 when the display driver circuit is in the non-active state.

The voltage generator 1510 or 1520 included in the power control circuit 1502 may be implemented by using a LDO, switching regulator, or any voltage regulator capable of generating a desired output voltage, but not limited thereto.

In one or some embodiments, the supply voltage VDD and/or VSS may be provided from an external power source, such as a power supply device, power management circuit or power control circuit externally connected to the display driver circuit. In such a situation, the internal circuit 1500 may receive the supply voltage VDD or VSS from the external power source in the normal power supply state. In addition, the internal circuit 1500 may receive the internal supply voltage VDD_INT or VSS_INT from the voltage generator 1510 or 1520 in the low power supply state, where the voltage generators 1510 and 1520 may be the power control circuits included in the display driver circuit. In this manner, the internal circuit 1500 may receive power supply from different power control circuits or power sources for the active state and the non-active state of the display driver circuit, thereby achieving power reduction of the internal circuit 1500 when the display driver circuit enters the non-active state.

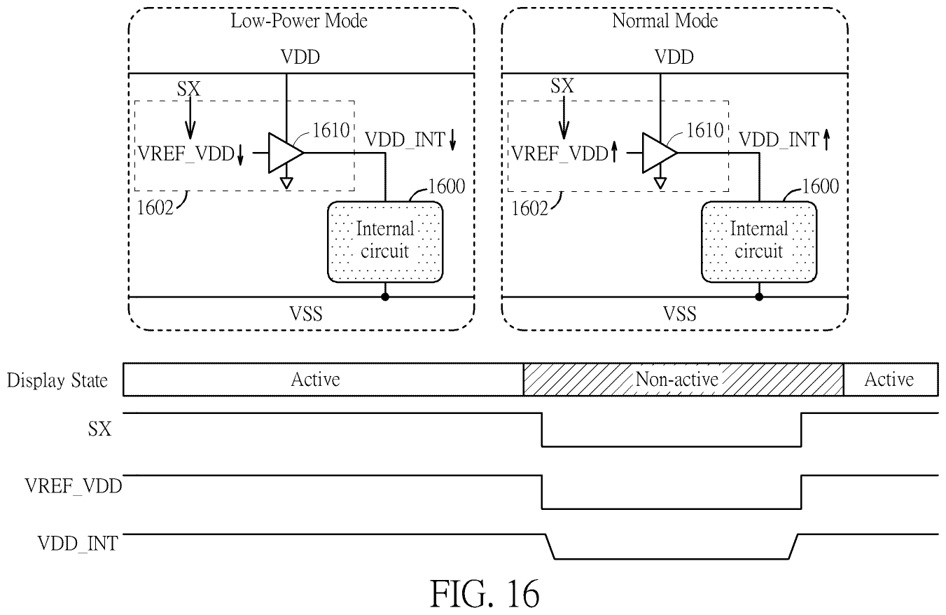

In another embodiment, a voltage generator for supplying voltage to the internal circuit is capable of outputting different voltage levels to control the internal circuit to operate in appropriate manners. For example, FIG. 16 illustrates another implementation of the power control circuit 1402 shown in FIG. 14A according to an embodiment of the present invention. In this embodiment, a power control circuit 1602 includes a voltage generator 1610. The voltage generator 1610, which is disposed between the voltage supply source providing the supply voltage VDD and an internal circuit 1600, is configured to generate the internal supply voltage VDD_INT by receiving the reference voltage VREF_VDD, and then supply the internal supply voltage VDD_INT to the internal circuit 1600. Through the control of the power control signal SX, the voltage generator 1610 may adjust the level of the internal supply voltage VDD_INT, which may be achieved by adjusting the level of the reference voltage VREF_VDD.

In detail, when the power control circuit 1602 operates in the normal mode, the voltage generator 1610 may receive a higher reference voltage VREF_VDD or increase the level of the reference voltage VREF_VDD, thereby outputting the internal supply voltage VDD_INT with a higher level to the internal circuit 1600. When the power control circuit 1602 operates in the low-power mode, the voltage generator 1610 may receive a lower reference voltage VREF_VDD or decrease the level of the reference voltage VREF_VDD, thereby outputting the internal supply voltage VDD_INT with a lower level to the internal circuit 1600. The level of the internal supply voltage VDD_INT in the low-power mode is lower than that in the normal mode, thereby reducing static power consumption of the internal circuit 1600 when the display driver circuit is in the non-active state.

Note that the above embodiment provides a voltage generator 1610 disposed between the voltage supply source providing the supply voltage VDD and the internal circuit 1600. In another embodiment, there may be a voltage generator disposed between the voltage supply source providing the supply voltage VSS and the internal circuit, to output different levels of the internal supply voltage VSS_INT under different operation modes. The related operations are similar to those described in the above embodiment, and will not be narrated herein.

Similarly, the voltage generator capable of adjusting the output voltage level for the internal circuit may be implemented by using a LDO, switching regulator, or any voltage regulator capable of generating a desired output voltage, but not limited thereto.

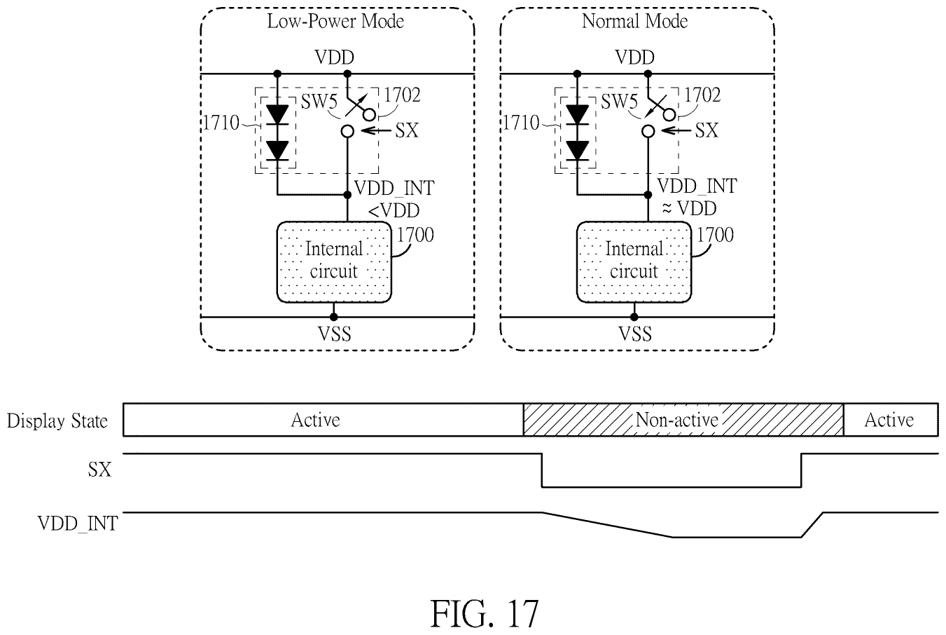

FIG. 17 illustrates a power control circuit 1702, which is a further implementation of the power control circuit 1402 shown in FIG. 14A according to an embodiment of the present invention. In this embodiment, the power control circuit 1702 includes a switch SW5 and a diode circuit 1710. The switch SW5 is disposed between the voltage supply source providing the supply voltage VDD and an internal circuit 1700, and controlled by the power control signal SX. The diode circuit 1710, which is disposed to connect the voltage supply source providing the supply voltage VDD and the internal circuit 1700 to form another power supply path, may include several diodes connected in series. FIG. 17 shows that the diode circuit 1710 includes two diodes, but those skilled in the art would know that a diode circuit may include any number of diodes connected in series. The number and deployment of the diodes may determine the magnitude of voltage drop, thereby determining the level of the internal supply voltage VDD_INT supplied by the diode circuit 1710.

When the power control circuit 1702 operates in the normal mode, the switch SW5 may be turned on to conduct the supply voltage VDD as the internal supply voltage VDD_INT to be supplied to the internal circuit 1700. In other words, the internal supply voltage VDD_INT is substantially equal to VDD. When the power control circuit 1702 operates in the low-power mode, the switch SW5 may be turned off to disconnect the voltage supply source from the internal circuit 1700, thereby cutting off the path of directly supplying the supply voltage VDD. At this time, the power may pass through the diode circuit 1710 to be supplied to the internal circuit 1700. Due to the voltage drop of the diodes, the internal supply voltage VDD_INT received by the internal circuit 1700 would be lower than the supply voltage VDD, thereby reducing static power consumption of the internal circuit 1700 when the display driver circuit is in the non-active state.

From another perspective, the implementation of the power control circuit 1702 shown in FIG. 17 may be considered as providing a smaller resistance to supply power when the switch SW5 is turned on (which corresponds to the normal power supply state), while providing a larger resistance to supply power when the switch SW5 is turned off (which corresponds to the low power supply state). That is, the power supply path of the diode circuit 1710 may have a larger resistance than the turn-on switch path. The larger resistance will reduce the overall current consumption, thereby reducing the power consumption of the internal circuit 1700 when the display driver circuit is in the non-active state.

In another embodiment, the diode circuit may be disposed between the voltage supply source providing the supply voltage VSS and the internal circuit. The related implementations are similar to those described in the above embodiment, and will not be narrated herein.

To sum up, the present invention provides a power reduction method for reducing static power consumption of internal circuits in a display driver circuit when the display driver circuit enters the non-active state where the display driver circuit stops receiving display data and refreshing the display panel. The display driver circuit may include a detector for detecting the display state of the display driver circuit and/or the operation mode of the display interface. Based on the detection result, the power control circuit is configured to operate in the normal mode or low-power mode, to provide different power supply states for the corresponding internal circuit. In an embodiment, the internal circuit may be provided with a larger resistance in its power supply path when it is in the low power supply state as compared to the situation in the normal power state. Alternatively or additionally, the power control circuit may provide a lower voltage across the internal circuit in the low-power mode as compared to that in the normal mode. As a result, the internal circuit may have less static power consumption when the display driver circuit is in the non-active state, thereby improving the power consumption performance of the display system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a display driver circuit comprising:
receiving display data through a display interface;
detecting whether the display driver circuit enters a non-active state in which the display driver circuit stops refreshing a display panel; and
in response to detecting that the display driver circuit enters the non-active state, configuring a power supply state for an internal circuit of the display driver circuit to save power consumption of the internal circuit.

2. The method of claim 1, wherein detecting whether the display driver circuit enters the non-active state comprises:
detecting whether the display interface transits from a first operation mode to a second operation mode, wherein the display interface transits to the second operation mode in response to receiving an indicating packet which indicates the second operation mode.

3. The method of claim 1, wherein detecting whether the display driver circuit enters the non-active state comprises:
detecting whether a counter starts counting, wherein the counter is configured to count a period during which the display driver circuit stays in the non-active state, which is determined according to a frame rate switch command.

4. The method of claim 1, wherein detecting whether the display driver circuit enters the non-active state comprises:
detecting whether a preconfigured signal received by the display driver circuit transits from a first logic level to a second logic level;
wherein the preconfigured signal with the first logic level is corresponding to an active state of the display driver circuit and the preconfigured signal with the second logic level is corresponding to the non-active state of the display driver circuit.

5. The method of claim 1, wherein configuring the power supply state for the internal circuit comprises:
outputting a power control signal with a second state to a power control circuit in response to detecting that the display driver circuit enters the non-active state; and
configuring the power supply state that is different than providing a first voltage, according to the power control signal with the second state, wherein the first voltage is provided by the power control circuit to the internal circuit according to the power control signal with a first state when the display driver circuit stays in an active state.

6. The method of claim 5, wherein configuring the power supply state for the internal circuit is to disconnect a voltage supply source from the internal circuit.

7. The method of claim 5, wherein configuring the power supply state for the internal circuit is to provide a second voltage that is lower than the first voltage.

8. The method of claim 5, wherein configuring the power supply state for the internal circuit is to control the internal circuit to receive a second voltage from another power control circuit.

9. The method of claim 1, further comprising:
counting a first period in response to detecting the display driver circuit enters the non-active state, wherein the first period is less than a period during which the display driver circuit stays in the non-active state; and
in response to an expiration of the first period, stopping configuring the power supply state for the internal circuit and providing a first voltage to the internal circuit instead.

10. The method of claim 9, further comprising:
counting a second period which starts from the expiration of the first period; and
in response to detecting that the display driver circuit still stays in the non-active state at an expiration of the second period, stopping providing the first voltage to the internal circuit and configuring the power supply state for the internal circuit instead.

11. A display driver circuit comprising:
a receiver to receive display data through a display interface;
a detector to detect whether the display driver circuit enters a non-active state in which the display driver circuit stops refreshing a display panel; and
a power control circuit, coupled to the detector, to configure a power supply state for an internal circuit of the display driver circuit in response to detecting that the display driver circuit enters the non-active state, to save power consumption of the internal circuit.

12. The display driver circuit of claim 11, wherein the detector detects whether the display driver circuit enters the non-active state by detecting whether the display interface transits from a first operation mode to a second operation mode, wherein the display interface transits to the second operation mode in response to receiving an indicating packet which indicates the second operation mode.

13. The display driver circuit of claim 11, wherein the detector detects whether the display driver circuit enters the non-active state by detecting whether a counter starts counting, wherein the counter is configured to count a period during which the display driver circuit stays in the non-active state, which is determined according to a frame rate switch command.

14. The display driver circuit of claim 11, wherein the detector detects whether the display driver circuit enters the non-active state by detecting whether a preconfigured signal received by the display driver circuit transits from a first logic level to a second logic level, wherein the preconfigured signal with the first logic level is corresponding to an active state of the display driver circuit and the preconfigured signal with the second logic level is corresponding to the non-active state of the display driver circuit.

15. The display driver circuit of claim 11, wherein the detector outputs a power control signal with a second state to the power control circuit in response to detecting that the display driver circuit enters the non-active state, and the power control circuit configures the power supply state that is different than providing a first voltage according to the power control signal with the second state, wherein the first voltage is provided by the power control circuit to the internal circuit according to the power control signal with a first state when the display driver circuit stays in an active state.

16. The display driver circuit of claim 15, wherein the power control circuit comprises a variable resistance circuit disposed between a voltage supply source and the internal circuit, wherein the variable resistance circuit generates a first resistance in response to detecting that the display driver circuit enters the active state and generates a second resistance that is greater than the first resistance in response to detecting that the display driver circuit enters the non-active state.

17. The display driver circuit of claim 15, wherein the power control circuit configures the power supply state for the internal circuit by using a switch for disconnecting a voltage supply source from the internal circuit.

18. The display driver circuit of claim 15, wherein the power control circuit configures the power supply state for the internal circuit by providing a second voltage that is lower than the first voltage.

19. The display driver circuit of claim 18, wherein the power control circuit comprises a switch and a voltage generator disposed between a voltage supply source and the internal circuit, and wherein in response to detecting that the display driver circuit enters the non-active state, the switch disconnects the voltage supply source from the internal circuit and the voltage generator outputs the second voltage to the internal circuit.

20. The display driver circuit of claim 18, wherein the power control circuit comprises a switch and a diode circuit disposed between a voltage supply source and the internal circuit, and wherein in response to detecting that the display driver circuit enters the non-active state, the switch disconnects the voltage supply source from the internal circuit and the diode circuit connects the voltage supply source and the internal circuit.

21. The display driver circuit of claim 18, wherein the power control circuit comprises a voltage generator, and wherein in response to detecting that the display driver circuit enters the non-active state, the voltage generator outputs the second voltage to the internal circuit.

22. The display driver circuit of claim 15, wherein the power control circuit configures the power supply state for the internal circuit by controlling the internal circuit to receive a second voltage from another power control circuit.

23. The display driver circuit of claim 11, further comprising:
a first counter for counting a first period in response to detecting the display driver circuit enters the non-active state, wherein the first period is less than a period during which the display driver circuit stays in the non-active state,
wherein in response to an expiration of the first counter, the power control circuit stops configuring the power supply state for the internal circuit and provides a first voltage to the internal circuit instead.

24. The display driver circuit of claim 23, further comprising:
a second counter for counting a second period which starts from the expiration of the first counter,
wherein in response to detecting that the display driver circuit still stays in the non-active state at an expiration of the second counter, the power control circuit stops providing the first voltage to the internal circuit and configures the power supply state for the internal circuit instead.
